(19) United States
(12) Patent Application Publication
(10) Pub. No.: US 2011/0234763 A1
(43) Pub. Date: Sep. 29, 2011

(54) APPARATUS AND METHOD FOR TRANSMITTING/RECEIVING MULTI-VIEW STEREOSCOPIC VIDEO

(75) Inventors: Bon-Woo HWANG, Daejeon (KR); Kap-Kee KIM, Daejeon (KR); Bonki KOO, Daejeon (KR)

(73) Assignee: Electronics and Telecommunications Research Institute, Daejeon (KR)

(21) Appl. No.: 12/909,518

(22) Filed: Oct. 21, 2010

(30) Foreign Application Priority Data
Mar. 29, 2010 (KR) 10-2010-0027803

(51) Int. Cl. H04N 13/02

(52) U.S. Cl. 348/47; 348/42; 348/E13.074; 348/E13.062

(57) ABSTRACT

An apparatus for transmitting a multi-view stereoscopic video includes: a control unit configured to receive a group of stereoscopic images taken by a plurality of stereoscopic imaging devices; a generation unit configured to select at least one stereoscopic frame from stereoscopic frames of the received group of stereoscopic images, arrange the selected stereoscopic frames successively, and generate a multi-view stereoscopic video; an encoding unit configured to encode the generated multi-view stereoscopic video; and a transmission unit configured to transmit the encoded multi-view stereoscopic video through a transmission network.

### CROSS-REFERENCE(S) TO RELATED APPLICATIONS

The present application claims priority of Korean Patent Application No. 10-2010-0027803, filed on Mar. 29, 2010, which is incorporated herein by reference in its entirety.

### BACKGROUND OF THE INVENTION

1. Field of the Invention

Exemplary embodiments of the present invention relate to an apparatus and a method for transmitting/receiving a multi-view stereoscopic video; and, more particularly, to an apparatus and a method for generating a multi-view stereoscopic video using a group of stereoscopic images taken at various viewpoints and transmitting/receiving the generated multi-view stereoscopic video.

2. Description of Related Art

Human eyes are spaced in the horizontal direction at a distance of about 65 mm, and binocular disparity resulting from the spacing is the most important factor of depth perception. Specifically, left and right eyes see different two-dimensional images, e.g. left and right images, which are transmitted to the brain through retinas. The brain then combines the left and right images so that the person perceives a stereoscopic image.

In addition to a method of relying on the binocular disparity to provide users with depth perception, there is also a multi-view method, which takes images by at least one camera, geometrically calibrates the images, and performs spatial synthesis, for example, to provide users with various views in different direction.

The multi-view method provides realistic images beyond the concept of high quality, and users are more immersed in media. Therefore, this method can deliver image information very efficiently in the fields of advertising, education, medical care, national defense, entertainment, etc.

Due to such characteristics, the multi-view method has developed in various types, e.g. omni-video which provides users with images in all directions, view switching which allows selection from images inputted from N cameras, panorama which provides a wider Field of View (FOV) of scenes around the user than conventional two-dimensional videos, etc.

However, the multi-view method has a problem in that image acquisition using this method requires synchronization between cameras, a large amount of data, and expensive equipment, and this requirement limits development of various services. Furthermore, related image acquisition methods or following image processing has a complicated structure.

### SUMMARY OF THE INVENTION

An embodiment of the present invention is directed to an apparatus and a method for transmitting/receiving a multi-view stereoscopic video.

Another embodiment of the present invention is directed to an apparatus and a method for generating a multi-view stereoscopic video using a group of stereoscopic images taken by a plurality of stereoscopic imaging devices at various viewpoints and transmitting/receiving the multi-view stereoscopic video.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an apparatus for transmitting a multi-view stereoscopic video includes: a control unit configured to receive a group of stereoscopic images taken by a plurality of stereoscopic imaging devices; a generation unit configured to select at least one stereoscopic frame from stereoscopic frames of the received group of stereoscopic images, arrange the selected stereoscopic frames successively, and generate a multi-view stereoscopic video; an encoding unit configured to encode the generated multi-view stereoscopic video; and a transmission unit configured to transmit the encoded multi-view stereoscopic video through a transmission network.

The apparatus may further include an intermediate view generation unit configured to generate a group of stereoscopic images having intermediate viewpoints different from viewpoints of the plurality of stereoscopic imaging devices.

In accordance with another embodiment of the present invention, an apparatus for receiving a multi-view stereoscopic video includes: a reception unit configured to receive a multi-view stereoscopic video through a transmission network; a decoding unit configured to decode the received multi-view stereoscopic video; and a display unit configured to display the decoded multi-view stereoscopic video.

In accordance with another embodiment of the present invention, a method for transmitting a multi-view stereoscopic video includes: receiving a group of stereoscopic images taken by a plurality of stereoscopic imaging devices; selecting at least one stereoscopic frame from stereoscopic frames of the received group of stereoscopic images, arranging the selected stereoscopic frames successively, and generating a multi-view stereoscopic video; encoding the generated multi-view stereoscopic video; and transmitting the encoded multi-view stereoscopic video through a transmission network.

The method may further include generating a group of stereoscopic images having intermediate viewpoints different from viewpoints of the plurality of stereoscopic imaging devices.

In accordance with another embodiment of the present invention, a method for receiving a multi-view stereoscopic video includes: receiving a multi-view stereoscopic video through a transmission network; decoding the received multi-view stereoscopic video; and displaying the decoded multi-view stereoscopic video.

### BRIEF DESCRIPTION OF THE DRAWINGS

FIG. 1 illustrates the internal structure of an apparatus for transmitting/receiving videos.

FIG. 2 illustrates the internal structure of an apparatus for transmitting/receiving videos.

FIG. 3 illustrates the internal structure of an apparatus for transmitting multi-view stereoscopic videos in accordance with an embodiment of the present invention.

FIG. 4 illustrates exemplary construction of multi-view stereoscopic cameras of an apparatus for transmitting multi-view stereoscopic videos in accordance with an embodiment of the present invention.

FIG. 5 illustrates a process of generating a multi-view stereoscopic video using a group of stereoscopic videos by a video generation unit 303 of an apparatus for transmitting multi-view stereoscopic videos in accordance with an embodiment of the present invention.

FIG. 6 illustrates exemplary construction of a monitor provided by a monitoring unit 311 and, as well as an input unit 312, of an apparatus for transmitting multi-view stereoscopic videos in accordance with an embodiment of the present invention.

FIG. 7 illustrates exemplary construction of a multi-view stereoscopic video generated by a video generation unit 303 of an apparatus for transmitting multi-view stereoscopic videos in accordance with an embodiment of the present invention.

FIG. 8 illustrates the internal structure of an apparatus for receiving multi-view stereoscopic videos in accordance with an embodiment of the present invention.

FIG. 9 illustrates a process of transmitting a multi-view stereoscopic video in accordance with an embodiment of the present invention.

FIG. 10 illustrates a process of receiving a multi-view stereoscopic video in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

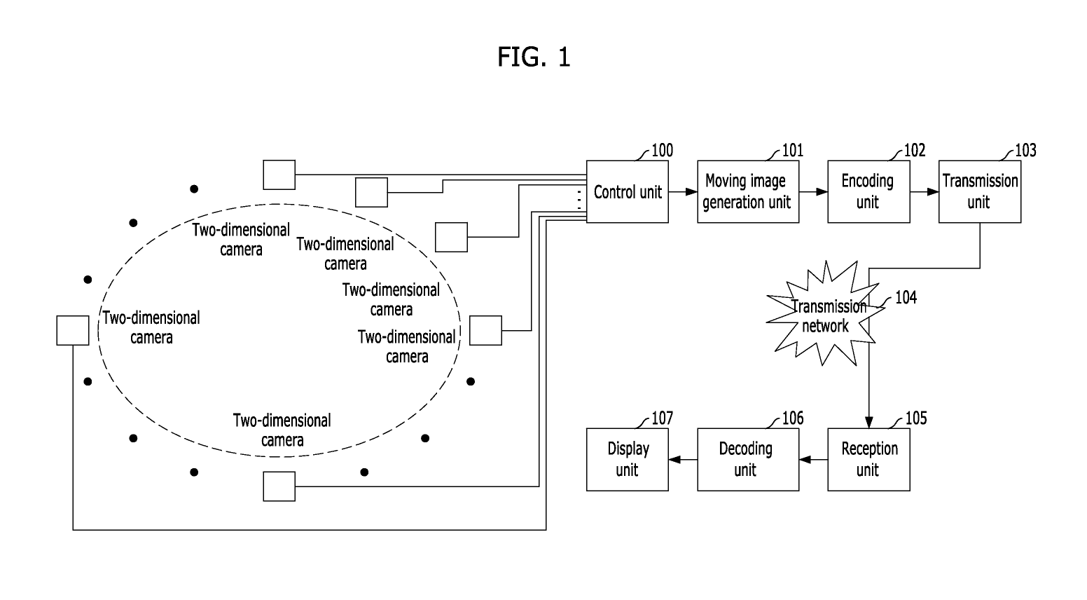

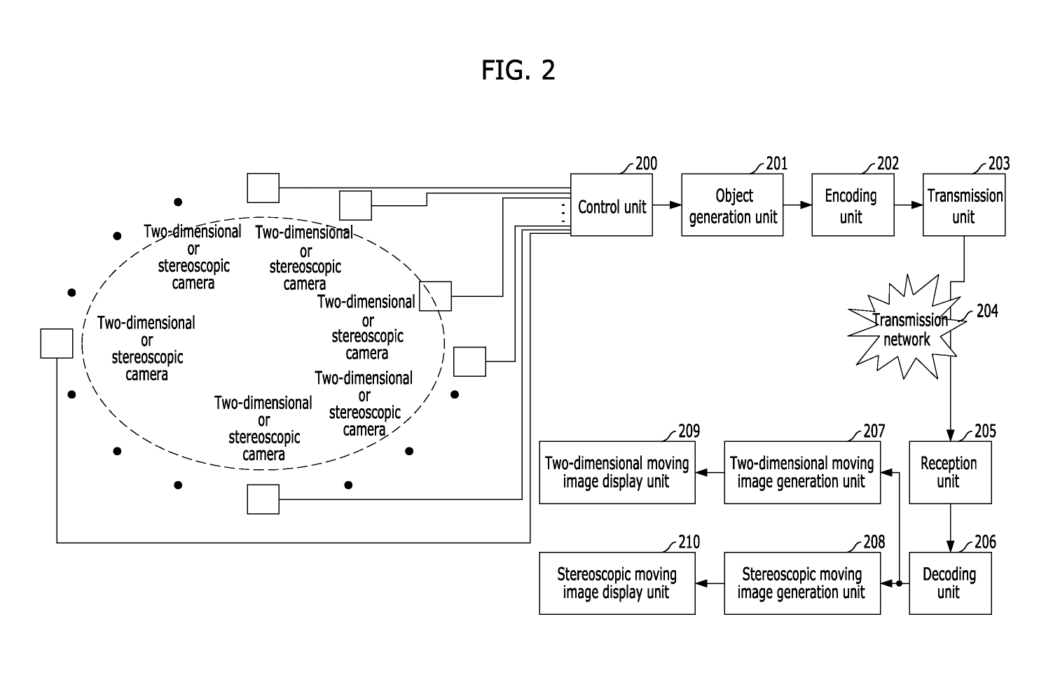

Exemplary apparatuses for transmitting/receiving videos will be described with reference to FIGS. 1 and 2.

FIG. 1 illustrates the internal structure of an apparatus for transmitting/receiving videos.

Referring to FIG. 1, the apparatus for transmitting/receiving videos includes a control unit 100, a video generation unit 101, an encoding unit 102, a transmission unit 103, a transmission network 104, a reception unit 105, a decoding unit 106, and a display unit 107.

The control unit 100 is configured to control the pan, tilt, and zoom of various types of a plurality of imaging devices, e.g. two-dimensional cameras and receive a group of two-dimensional images taken by the two-dimensional cameras. The video generation unit 101 is configured to select frames taken at suitable time and viewpoint from frames of the group of two-dimensional images and generate a two-dimensional video.

The encoding unit 102 is configured to compress and encode the generated two-dimensional video. The transmission unit 103 is configured to transmit the encoded two-dimensional video to the reception unit 105 through the transmission network 104, which may be a broadcasting network or a wired/wireless network, but is not limited thereto. The reception unit 105 is configured to receive a two-dimensional video. The decoding unit 106 is configured to decode the received two-dimensional video. The display unit 107 is configured to display the two-dimensional video.

This type of apparatuses for transmitting/receiving videos can provide users with a special type of two-dimensional videos, which consist of frames of specific viewpoint and time on space and time axes, and are used for CF photography, special effects for films, sports broadcasting, etc, but cannot express stereoscopic images through a stereoscopic video display unit, such as 3DTV.

FIG. 2 illustrates the internal structure of an apparatus for transmitting/receiving videos.

Referring to FIG. 2, the apparatus for transmitting/receiving videos includes a control unit 200, an object generation unit 201, an encoding unit 202, a transmission unit 203, a transmission network 204, a reception unit 205, a decoding unit 206, a two-dimensional video generation unit 207, a stereoscopic video generation unit 208, a two-dimensional video display unit 209, and a stereoscopic video display unit 210.

The control unit 200 is configured to control the pan, tilt, and zoom of various types of a plurality of imaging devices, e.g. two-dimensional or stereoscopic cameras and receive a group of two-dimensional or stereoscopic images taken by the two-dimensional or stereoscopic cameras. The object generation unit 201 is configured to continuously generate three-dimensional graphic objects from the group of two-dimensional or stereoscopic images.

The encoding unit 202 is configured to compress and encode the three-dimensional graphic objects. The transmission unit 203 is configured to transmit the encoded three-dimensional graphic objects to the reception unit 205 through the transmission network 204, which may be a broadcasting network or a wired/wireless network, but is not limited thereto.

The reception unit 205 is configured to receive the three-dimensional graphic objects. The decoding unit 206 is configured to decode the received three-dimensional graphic objects. The two-dimensional video generation unit 207 is configured to generate a two-dimensional video from the three-dimensional graphic objects using graphic rendering technology. The stereoscopic video generation unit 208 is configured to generate a stereoscopic video from three-dimensional graphic objects using graphic rendering technology.

The two-dimensional image display unit 209 is configured to display the two-dimensional video generated by the two-dimensional video generation unit 207. The stereoscopic image display unit 210 is configured to display the stereoscopic video generated by the stereoscopic video generation unit 208.

The apparatus is advantageous in that, from three-dimensional graphic objects, two-dimensional or stereoscopic videos can be generated which are given graphic effects, such as addition of various types of lighting, addition and deletion of stereoscopic objects, synthesis of various two-dimensional or stereoscopic backgrounds, selection of a specific viewpoint, and the like.

However, the apparatus has the following problems: the process of generating three-dimensional graphic objects from the group of two-dimensional images by the object generation unit 201 is very complicated and requires a large amount of calculation. The number of three-dimensional graphic objects is limited, and the type of objects that can be generated is limited by the degree of opaqueness of objects, overlapping between object components, and the like. The time necessary to generate three-dimensional graphic objects is too long to guarantee real-time proceeding from photography to stereoscopic image display.

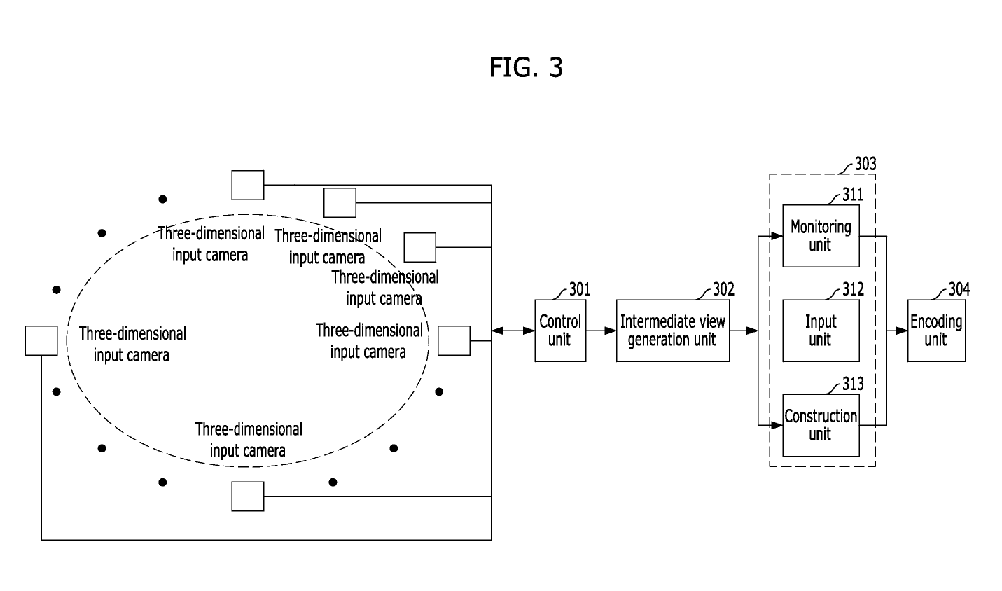

Furthermore, the process of rendering images by the two-dimensional video generation unit 207 or the stereoscopic video generation unit 208, which is needed to express three-dimensional graphic objects as high-quality images comparable to real pictures through the two-dimensional image display unit 209 or the stereoscopic video display unit 210, requires very complicated calculation and long time. It is even more difficult to obtain high-quality images comparable to real pictures of the actual world. The internal structure of an apparatus for transmitting multi-view stereoscopic videos in accordance with an embodiment of the present invention will now be described in more detail with reference to FIG. 3.

FIG. 3 illustrates the internal structure of an apparatus for transmitting multi-view stereoscopic videos in accordance with an embodiment of the present invention.

Referring to FIG. 3, the apparatus for transmitting multi-view stereoscopic videos includes a control unit 301, an intermediate view generation unit 302, a video generation unit 303, an encoding unit 304, and a transmission unit 305. The video generation unit 303 includes a monitoring unit 311, an input unit 312, and a construction unit 313. Although not shown in FIG. 3, the control unit 301 includes a storage unit.

The control unit 301 is configured to receive a group of stereoscopic images from various types of a plurality of stereoscopic imaging devices, e.g. multi-view stereoscopic cameras. The control unit 301 is configured to receive a group of stereoscopic images and, when analog stereoscopic images have been received, convert the analog stereoscopic images into digital stereoscopic images and store the digital stereoscopic images in the storage unit of the control unit 301. The storage unit of the control unit 301 may be a RAM, a hard disk, etc.

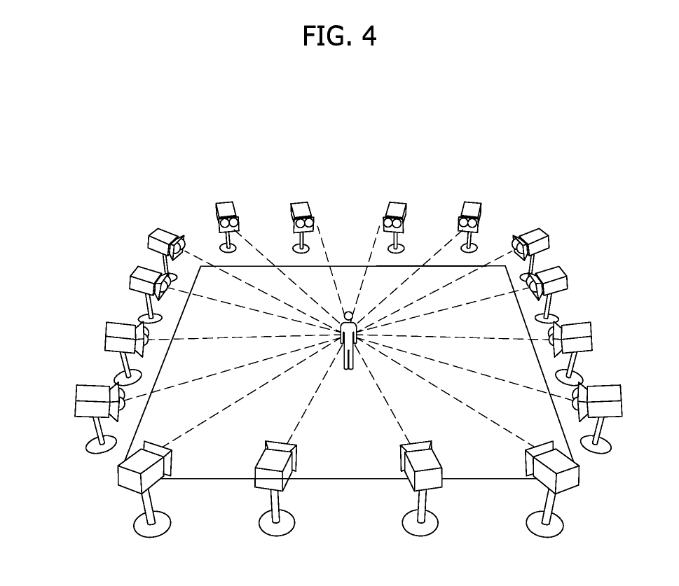

The multi-view stereoscopic cameras may include mounting units (not shown) configured to perform the functions of pan, tilt, zoom, etc. The pan, tilt, and zoom of the mounting units are controlled by the control unit 301. FIG. 4 illustrates exemplary construction of multi-view stereoscopic cameras of an apparatus for transmitting multi-view stereoscopic videos in accordance with an embodiment of the present invention. The multi-view stereoscopic cameras are arranged at such viewpoints that objects and backgrounds are best expressed, and are installed on camera mounting units, the pan and tilt of which are controlled by the control unit 301.

The intermediate view generation unit 302 is configured to receive a group of stereoscopic images taken by the multi-view stereoscopic cameras from the storage unit of the control unit 301. The intermediate view generation unit 302 is configured to generate a group of stereoscopic images having virtual viewpoints different from the viewpoints of the multi-view stereoscopic cameras used to take the group of stereoscopic images.

Generally, in the case of stereoscopic multi-view images providing realistic feeling and depth perception, limitations on the number of multi-view stereoscopic cameras and the spacing between them may cause visual discontinuity in viewpoint transition. The intermediate view generation unit 302 can be selectively used to solve such a problem.

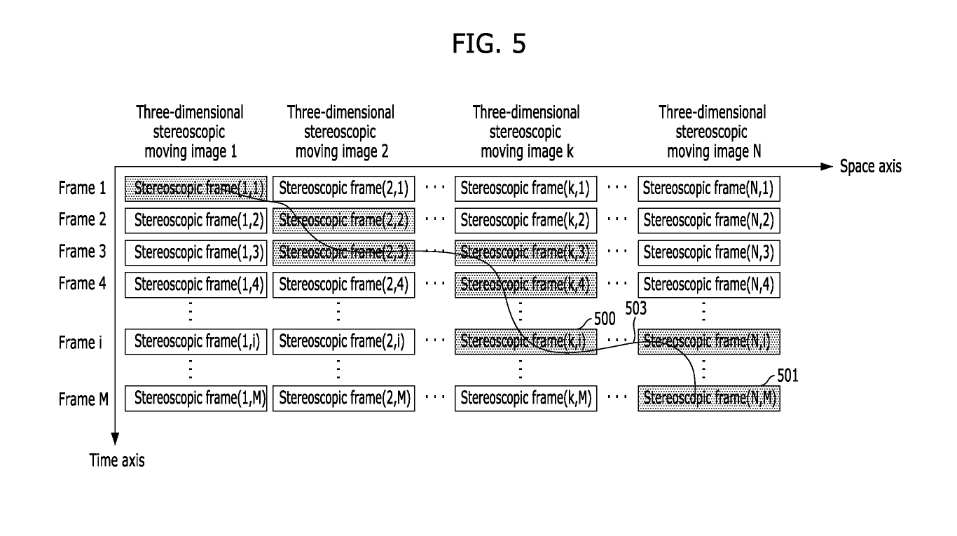

The video generation unit 303 is configured to receive a group of stereoscopic images, which have been taken by the multi-view stereoscopic cameras, from the storage unit of the control unit 301 or from the intermediate view generation unit 302, and generate a multi-view stereoscopic video by rearranging images belonging to the group at the request of the user. The group of stereoscopic images consists of stereoscopic frames as illustrated in FIG. 5.

Each of the stereoscopic frames includes stereoscopic image information, e.g. left and right images, which makes it possible to express stereoscopic images through the display unit 803 (described later). The structure of a group of stereoscopic images received from multi-view stereoscopic cameras by an apparatus for transmitting multi-view stereoscopic videos in a multi-view image system in accordance with an embodiment of the present invention will be described in more detail with reference to FIG. 5.

FIG. 5 illustrates the structure of a group of stereoscopic images received from multi-view stereoscopic cameras by an apparatus for transmitting multi-view stereoscopic videos in a multi-view image system in accordance with an embodiment of the present invention.

Referring to FIG. 5, the group of stereoscopic images received from the storage unit of the control unit 301 or from the intermediate view generation unit 302 consists of stereoscopic frames, which are described with reference to space axis (X-axis) and time axis (Y-axis). In the case of stereoscopic frame (k, i) 500, k refers to image index, and i refers to frame index.

The image index k is used to identify an image taken by a multi-view stereoscopic camera or an image generated by the intermediate view generation unit 302. The frame index i is used to indicate i^{th} stereoscopic frame among frames taken at respective viewpoints under synchronization or generated by the intermediate view generation unit 302.

In the case of stereoscopic frame (N, M) 501, N refers to the number of images, and M refers to the number of image frames. In the case of real-time broadcasting, the frame number of each image set, i.e. M, is not determined in advance.

The input unit 312 is configured to receive generation information of images to be generated from the user. The generation information includes stereoscopic frames to be used for stereoscopic images, the order of arranging stereoscopic frames, etc.

The input unit 312 is configured to receive stereoscopic frames selected by the user, e.g. stereoscopic frame (1, 1), stereoscopic frame (2, 2), stereoscopic frame (2, 3), stereoscopic frame (k, 3), stereoscopic frame (k, 4), stereoscopic frame (k, i), stereoscopic frame (N, i), and stereoscopic frame (N, M).

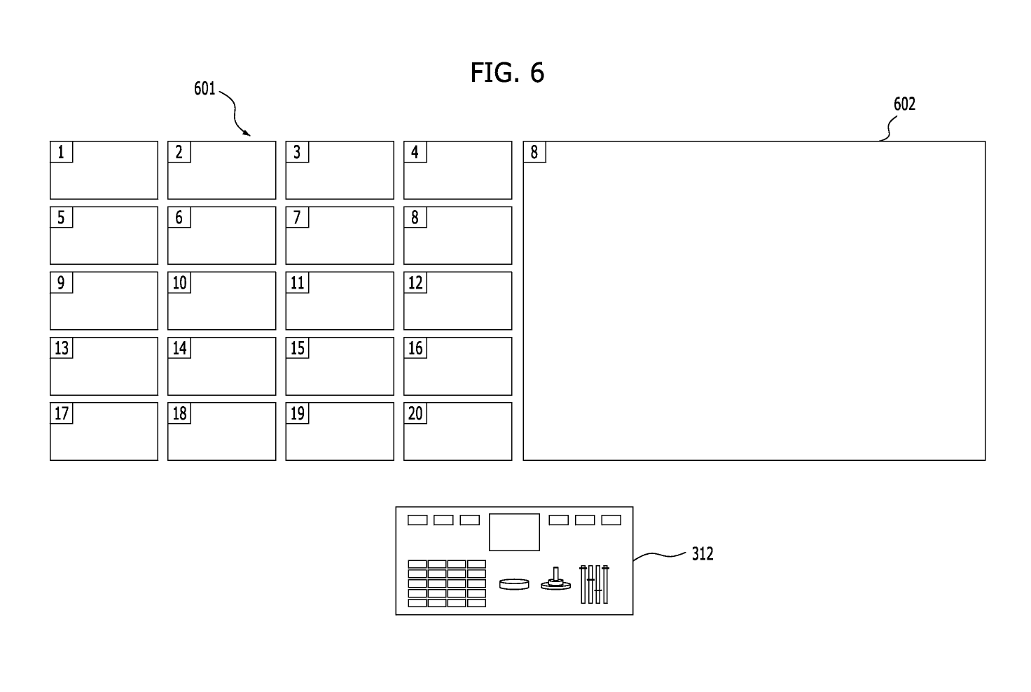

The user then can monitor stereoscopic frames of entire stereoscopic images belonging to the group of stereoscopic images, which have been received from the storage unit of the control unit 301 or from the intermediate view generation unit 302, using a monitor provided by the monitoring unit 311. Exemplary construction of a monitor provided by a monitoring unit 311, as well as an input unit 312, of an apparatus for transmitting multi-view stereoscopic videos in accordance with an embodiment of the present invention will be described in more detail with reference to FIG. 6.

FIG. 6 illustrates exemplary construction of a monitor provided by a monitoring unit 311, as well as an input unit 312, of an apparatus for transmitting multi-view stereoscopic videos in accordance with an embodiment of the present invention.

Referring to FIG. 6, the monitoring unit 311 is configured to provide the user with a monitor as illustrated in FIG. 6 so that the user can monitor stereoscopic frames constituting a group of stereoscopic images. Specifically, the monitoring unit 311 includes a display 601 so that a group of twenty stereoscopic images can be displayed simultaneously through screen division of a stereoscopic video display device (e.g. 3DTV) or two-dimensional image display device (two-dimensional monitor).

The monitoring unit 311 also includes a display 602 so that a stereoscopic frame selected by the user is magnified for detailed review. The construction of the displays can be varied according to the number of stereoscopic frames selected by the user or as needed by the user.

The user can use the input unit 312 to select the screen layout of the two-dimensional or stereoscopic video display device, e.g. determine the number of stereoscopic frames displayed on the screen, the group of stereoscopic images of specific viewpoints displayed on each screen devision, etc.

The user can also use the input unit 312 to freely move frame by frame in region, which consists of stereoscopic frames on space and time axes, and select a stereoscopic frame of interest so that it can be displayed through the monitor of the monitoring unit 311.

The user can use the input unit 312 to select each stereoscopic frame, which can best express objects and backgrounds, so that they are arranged in the desired order. The user can instruct the construction unit 313 to construct a multi-view stereoscopic video using the stereoscopic frames selected by the input unit 312.

The construction unit 313 is configured to receive stereoscopic frames selected by the user, arrange the stereoscopic frames in the order 503 selected by the user, and generate a multi-view stereoscopic video.

The order of stereoscopic frames constituting the generated multi-view stereoscopic video may be different from the time order in which a group of stereoscopic images have been taken by multi-view stereoscopic cameras, or from the time order in which a group of images have been generated by the intermediate view generation unit 302.

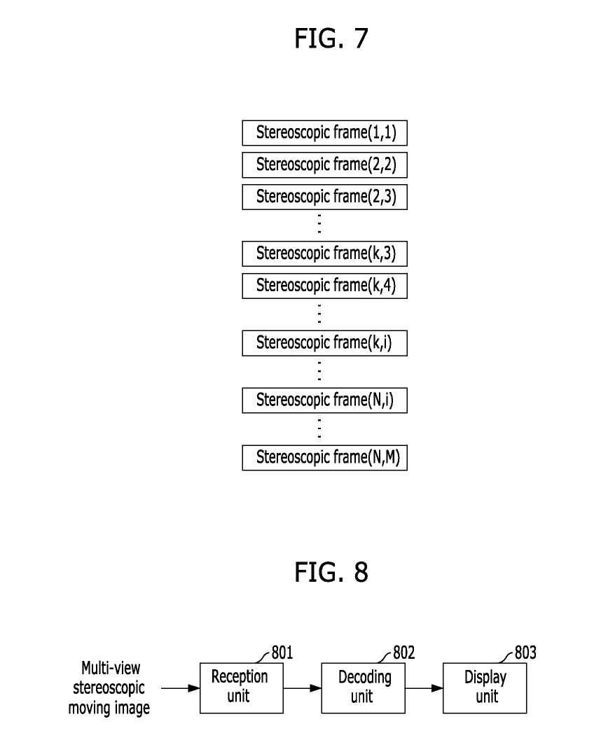

For example, according to the user's selection, a stereoscopic video may be constructed by successively arranging stereoscopic frames, which have the same time on the time axis and different viewpoints on the space axis, or by arranging stereoscopic frames in the backward direction on the time axis, i.e. in the reverse time order. Exemplary construction of a group of stereoscopic images generated by a video generation unit 303 of an apparatus for transmitting multi-view stereoscopic videos in accordance with an embodiment of the present invention will be described in more detail with reference to FIG. 7.

FIG. 7 illustrates exemplary construction of a group of stereoscopic images generated by a video generation unit 303 of an apparatus for transmitting multi-view stereoscopic videos in accordance with an embodiment of the present invention.

Referring to FIG. 7, the multi-view stereoscopic video generated by the video generator 303 has the following construction: stereoscopic frames arranged from (2, 3) to (k, 3), as well as from (k, i) to (N, i), have been selected by the user so as to have the same time on the time axis and different viewpoints.

Stereoscopic frames arranged from (2, 2) to (2, 3), from (k, 3) to (k, i), and from (N, i) to (N, M) have different time on the time axis and the same viewpoint on the space axis.

The encoding unit 304 is configured to receive a multi-view stereoscopic video generated by the video generation unit 303 and encode the multi-view stereoscopic video. The transmission unit 305 is configured to transmit the encoded multi-view stereoscopic video to an apparatus for receiving multi-view stereoscopic videos through the transmission network (not shown). The internal structure of an apparatus for receiving multi-view stereoscopic videos in accordance with an embodiment of the present invention will be described in more detail with reference to FIG. 8.

FIG. 8 illustrates the internal structure of an apparatus for receiving multi-view stereoscopic videos in accordance with an embodiment of the present invention.

Referring to FIG. 8, the apparatus for receiving multi-view stereoscopic videos includes a reception unit 801, a decoding unit 802, and a display unit 803. The reception unit 801 is configured to receive a multi-view stereoscopic video from the apparatus for transmitting multi-view stereoscopic videos through the transmission network. The decoding unit 802 is configured to decode the multi-view stereoscopic video. The display unit 803 is configured to display the multi-view stereoscopic video.

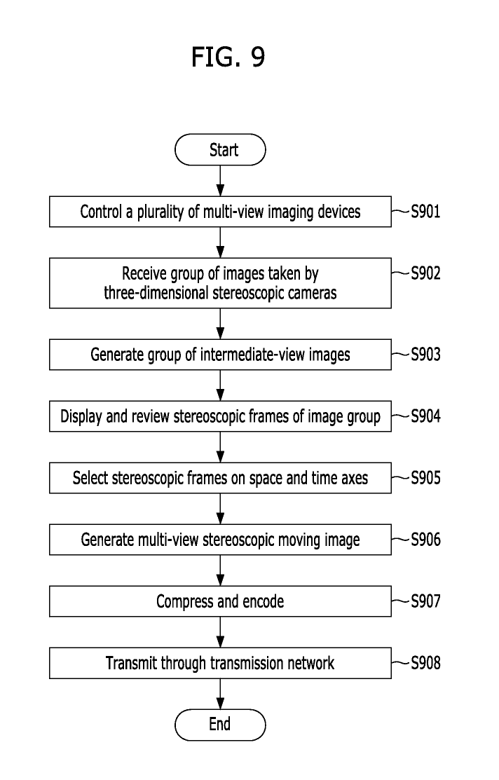

A process of transmitting a multi-view stereoscopic video in accordance with an embodiment of the present invention will be described in more detail with reference to FIG. 9.

FIG. 9 illustrates a process of transmitting a multi-view stereoscopic video in accordance with an embodiment of the present invention.

Referring to FIG. 9, the control unit 301 controls the pan, tilt, and zoom of stereoscopic imaging devices, e.g. multi-view stereoscopic cameras, at step S901. The control unit 301 receives a group of stereoscopic images taken by the multi-view stereoscopic cameras at step S902 and, when a group of analog images have been received, converts the analog images into digital images and stores the digital images in the storage unit of the control unit 301. The storage unit may be a RAM, a hard disk, etc.

Stereoscopic images belonging to the group, e.g. left and right stereoscopic images may have been taken by various types of multi-view stereoscopic cameras. The multi-view stereoscopic cameras are arranged at viewpoints that can best express objects and backgrounds, and are installed on camera mounting units, the pan and tilt of which are controlled by the control unit 301.

The intermediate view generation unit 302 receives the group of stereoscopic images, which have been taken by the multi-view stereoscopic cameras, from the storage unit and generates a group of stereoscopic images having intermediate viewpoints different from the viewpoints of the multi-view stereoscopic cameras used to take the group of stereoscopic images at step S903.

The user monitors frames using the monitor provided by the monitoring unit 311 at step S904. The user uses the monitor of the monitoring unit 311 to freely move frame by frame in region, which consists of stereoscopic frames on space and time axes, to select a stereoscopic frame of interest using the input unit 312 at step S905.

The user uses the input unit 312 to select each stereoscopic frame, which can best express objects and backgrounds, so that they are arranged in the desired order. The user also instructs the construction unit 313 to construct a multi-view stereoscopic video using the stereoscopic frames selected using the input unit 312.

The construction unit 313 receives stereoscopic frames selected by the user, arranges the stereoscopic frames in the order 503 selected by the user, and generates a multi-view stereoscopic video at step S906. The order of stereoscopic frames constituting the generated multi-view stereoscopic video may be different from the time order in which a group of stereoscopic images have been taken by multi-view stereoscopic cameras, or from the time order in which a group of stereoscopic images have been generated by the intermediate view generation unit 302.

For example, according to the user's selection, a stereoscopic video may be constructed by successively arranging stereoscopic frames, which have the same time on the time axis and different viewpoints on the space axis, or by arranging stereoscopic frames in the backward direction on the time axis, i.e. in the reverse time order.

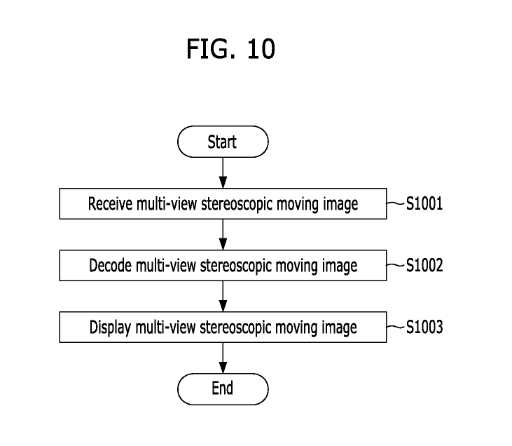

The encoding unit 304 compresses and encodes the multi-view stereoscopic video at step S907, and transmits the multi-view stereoscopic video to the apparatus for receiving multi-view stereoscopic videos through the transmission network at step S908. A process of receiving multi-view stereoscopic videos in accordance with an embodiment of the present invention will be described in more detail with reference to FIG. 10.

FIG. 10 illustrates a process of receiving multi-view stereoscopic videos in accordance with an embodiment of the present invention.

Referring to FIG. 10, the reception unit 801 receives a multi-view stereoscopic video from the apparatus for transmitting multi-view stereoscopic videos through the transmission network at step S1001. The decoding unit 802 decodes the multi-view stereoscopic video at step S1002. The display unit 803 displays the received multi-view stereoscopic video at step S1003.

While the present invention has been described with respect to the specific embodiments, it will be apparent to those skilled in the art that various changes and modifications may be made without departing from the spirit and scope of the invention as defined in the following claims.

What is claimed is:

1. An apparatus for transmitting a multi-view stereoscopic video, comprising:
a control unit configured to receive a group of stereoscopic images taken by a plurality of stereoscopic imaging devices;
a generation unit configured to select at least one stereoscopic frame from stereoscopic frames of the received group of stereoscopic images, arrange the selected stereoscopic frames successively, and generate a multi-view stereoscopic video;
an encoding unit configured to encode the generated multi-view stereoscopic video; and
a transmission unit configured to transmit the encoded multi-view stereoscopic video through a transmission network.

2. The apparatus of claim 1, further comprising an intermediate view generation unit configured to generate a group of stereoscopic images having intermediate viewpoints different from viewpoints of the plurality of stereoscopic imaging devices.

3. The apparatus of claim 1, wherein the control unit is configured to control pan, tilt, and zoom of the plurality of stereoscopic imaging devices.

4. The apparatus of claim 1, wherein the generation unit further comprises a monitoring unit configured to monitor stereoscopic frames of the received group of stereoscopic images.

5. The apparatus of claim 1, wherein the generation unit comprises an input unit configured to enable frame by frame movement in region, stereoscopic frames constituting the space on time and space axes.

6. The apparatus of claim 5, wherein the input unit is configured to select an order of arranging frames used to generate a multi-view stereoscopic video.

7. The apparatus of claim 6, wherein the generation unit further comprises a construction unit configured to arrange, according to the order of stereoscopic frames selected by the input unit, the stereoscopic frames successively.

8. The apparatus of claim 1, wherein the multi-view stereoscopic video has an order different from a time order in which the group of stereoscopic images have been taken.

9. An apparatus for receiving a multi-view stereoscopic video, comprising:
a reception unit configured to receive a multi-view stereoscopic video through a transmission network;
a decoding unit configured to decode the received multi-view stereoscopic video; and
a display unit configured to display the decoded multi-view stereoscopic video.

10. A method for transmitting a multi-view stereoscopic video, comprising:
receiving a group of stereoscopic images taken by a plurality of stereoscopic imaging devices;
selecting at least one stereoscopic frame from stereoscopic frames of the received group of stereoscopic images, arranging the selected stereoscopic frames successively, and generating a multi-view stereoscopic video;
encoding the generated multi-view stereoscopic video; and
transmitting the encoded multi-view stereoscopic video through a transmission network.

11. The method of claim 10, further comprising generating a group of stereoscopic images having intermediate viewpoints different from viewpoints of the plurality of stereoscopic imaging devices.

12. The method of claim 10, further comprising controlling pan, tilt, and zoom of the plurality of stereoscopic imaging devices.

13. The method of claim 10, wherein said selecting at least one stereoscopic frame from stereoscopic frames of the received group of stereoscopic images, arranging the selected stereoscopic frames successively, and generating a multi-view stereoscopic video comprises:
monitoring stereoscopic frames of the received group of stereoscopic images.

14. The method of claim 10, wherein said selecting at least one stereoscopic frame from stereoscopic frames of the received group of stereoscopic images, arranging the selected stereoscopic frames successively, and generating a multi-view stereoscopic video comprises:
enabling frame by frame movement in region, stereoscopic frames constituting the space on time and space axes.

15. The method of claim 10, wherein said selecting at least one stereoscopic frame from stereoscopic frames of the received group of stereoscopic images, arranging the selected stereoscopic frames successively, and generating a multi-view stereoscopic video comprises:
selecting an order of arranging frames used to generate a multi-view stereoscopic video.

16. The method of claim 10, wherein said selecting at least one stereoscopic frame from stereoscopic frames of the received group of stereoscopic images, arranging the selected stereoscopic frames successively, and generating a multi-view stereoscopic video comprises:
arranging, according to the order of stereoscopic frames selected by an input unit, the stereoscopic frames successively.

17. The method of claim 10, wherein the multi-view stereoscopic video has an order different from a time order in which the group of stereoscopic images have been taken.

18. A method for receiving a multi-view stereoscopic video, comprising:
receiving a multi-view stereoscopic video through a transmission network;
decoding the received multi-view stereoscopic video; and
displaying the decoded multi-view stereoscopic video.
